(19) United States
(12) Patent Application Publication
(10) Pub. No.: US 2015/0050459 A1
(43) Pub. Date: Feb. 19, 2015

(54) THREE-DIMENSIONALLY SHAPED STRUCTURE HAVING HYDROPHOBIC SURFACE, AND METHOD FOR MANUFACTURING SAME

(71) Applicants: Geunbae Lim, Pohang-si (KR); Taechang An, Pohang-si (KR)

(72) Inventors: Geunbae Lim, Pohang-si (KR); Taechang An, Pohang-si (KR)

(73) Assignee: POSTECH ACADEMY-INDUSTRY FOUNDATION, Pohang-si (KR)

(21) Appl. No.: 14/381,284

(22) PCT Filed: Aug. 30, 2012
(86) PCT No.: PCT/KR2012/006940

§ 371 Date: Aug. 27, 2014

(30) Foreign Application Priority Data
Feb. 29, 2012 (KR) 10-2012-0021203

(51) Int. Cl. C08J 7/04; B05D 3/14; B05D 5/00

(52) U.S. Cl. CPC C08J 7/047; B05D 5/00; B05D 3/14; C08J 2365/00; C08J 2427/18; C08J 2379/02
USPC 428/142; 427/256; 427/487

(57) ABSTRACT

A 3D-shaped structure having a hydrophobic surface according to the present invention includes a substrate, a protrusion and depression portion formed on the substrate, and a protective film formed on the protrusion and depression portion, in which the protrusion and depression portion includes at least one of a first protrusion and depression portion including a plurality of micro-protrusions, and the second protrusion and depression portion including a plurality of nano-fibers.

### TECHNICAL FIELD

The present invention relates to a 3D-shaped structure having a hydrophobic surface and a method of manufacturing the same.

### BACKGROUND ART

Generally, a surface of a solid base material such as a metal or a polymer has intrinsic surface energy. This is exhibited by a contact angle between a liquid and a solid when a predetermined liquid comes into contact with the solid base material.

Water that is a representative liquid has a hydrophilic characteristic in that spherical water drops lose shapes thereof on the solid surface to wet the surface in the case where a size of the contact angle is less than 90°. Further, in the case where the size of the contact angle is more than 90°, water has a hydrophobic characteristic where water drops maintain spherical shapes on the solid surface and do not wet the surface but easily flow by a small external force.

If the intrinsic contact angle of the surface of the solid base material is changed, hydrophilicity and hydrophobicity may be further increased.

Particularly, if the hydrophobic surface is applied to a light distribution structure, sliding of a liquid flowing in a pipe becomes easier to increase a flux and a flow rate thereof. Accordingly, when the hydrophobic surface is applied to a water pipe or a boiler pipe, accumulation of impurities may be significantly reduced. Further, corrosion of an internal wall of the pipe may be prevented to reduce water pollution.

However, a technology of changing the contact angle of the solid surface for a predetermined purpose is a MEMS (microelectromechanical system) process where a semiconductor manufacturing technology is applied, and a high cost is required. Further, work such as oxidation of a metal surface, application of a predetermined temperature and voltage, and etching are performed, and thus a process is complicated.

The above information disclosed in this Background section is only for enhancement of understanding of the background of the invention and therefore it may contain information that does not form the prior art that is already known in this country to a person of ordinary skill in the art.

### DISCLOSURE

### Technical Problem

Therefore, the present invention has been made in an effort to provide a 3D-shaped structure having a hydrophobic surface, and a method of manufacturing the same, in which a manufacturing process is simple and mass production is feasible at a low manufacturing cost.

### Technical Solution

An exemplary embodiment of the present invention provides a 3D-shaped structure having a hydrophobic surface, including: a substrate; a protrusion and depression portion formed on the substrate; and a protective film formed on a second protrusion and depression portion, in which the protrusion and depression portion includes at least one of a first protrusion and depression portion including a plurality of micro-protrusions and the second protrusion and depression portion including a plurality of nano-fibers.

The first protrusion and depression portion may include at least one selected from polypyrrole (PPy), polyaniline (PANI), and poly(3,4-ethylenedioxythiophene) (PEDOT).

The second protrusion and depression portion may include polyaniline.

The protective film may include Teflon or alkyltrichlorosilane.

The first protrusion and depression portion may have a thickness of 100 μm or less, and a height of the micro-protrusion may be 1 μm or less.

The second protrusion and depression portion may have a thickness of 1 μm or less, and the nano-fiber may have a diameter of 200 nm or less and a length of 1 μm or less.

Another exemplary embodiment of the present invention provides a method of manufacturing a 3D-shaped structure having a hydrophobic surface, including: forming a protrusion and depression portion on a substrate; and forming a hydrophobic protective film on the protrusion and depression portion, in which the forming of the protrusion and depression portion includes at least one of forming a first protrusion and depression portion including a plurality of micro-protrusions, and forming a second protrusion and depression portion including a plurality of nano-fibers.

The first protrusion and depression portion may be formed by electropolymerization, and the second protrusion and depression portion may be formed by chemical polymerization.

The electropolymerization may be performed in a water-soluble electrolyte solution including sodium dodecyl sulfate (SDS), hydrochloric acid (HCl), and pyrrole.

The chemical polymerization may be performed in an aqueous solution including 0.1 M to 1 M perchloric acid (HClO₄), 1 mM to 10 mM ammonium persulfate (APS), and 1 mM to 50 mM aniline.

### Advantageous Effects

A method of manufacturing a 3D-shaped structure according to the exemplary embodiments of the present invention has merits in that hydrophobicity is provided to an internal surface or an external surface of the 3D-shaped structure, and the method is relatively low in price and simple.

### DESCRIPTION OF THE DRAWINGS

FIG. 1 is a schematic cross-sectional view of a substrate for adjusting a contact angle according to an exemplary embodiment of the present invention.

FIG. 2 is a flowchart illustrating a method of manufacturing a 3D-shaped structure having a hydrophobic surface according to the exemplary embodiment of the present invention.

FIGS. 3A to 3D are schematic 3D views sequentially illustrating a method of forming a hydrophobic structure according to the exemplary embodiment of the present invention.

FIG. 4A is a SEM photograph of a PPy-SS mesh according to Example 1 of the present invention.

FIG. 4B is a SEM photograph of a PANI-SS mesh according to Example 2 of the present invention.

FIG. 4C is a SEM photograph of a PANI-PPy-SS mesh according to Example 3 of the present invention.

FIG. 4D is a SEM photograph of a Tef-PANI-PPy-SS mesh according to Example 3 of the present invention.

FIG. 5 is a graph obtained by measuring a static water contact angle and contact angle hysteresis of Comparative Examples 1 and 2 according to the related art and Examples 1 to 3 according to the present invention.

FIG. 6 is a graph obtained by measuring cos θ and static and dynamic water pressure resistances of Comparative Examples 1 and 2 according to the related art and Examples 1 to 3 according to the present invention.

FIGS. 7A to 7C are continuous photographs of intrusion of water drops in Comparative Examples 1 and 2 according to the related art and Example 3 of the present invention.

### MODE FOR INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

Hereinafter, a 3D-shaped structure having a hydrophobic surface according to an exemplary embodiment of the present invention will be specifically described with reference to the drawings.

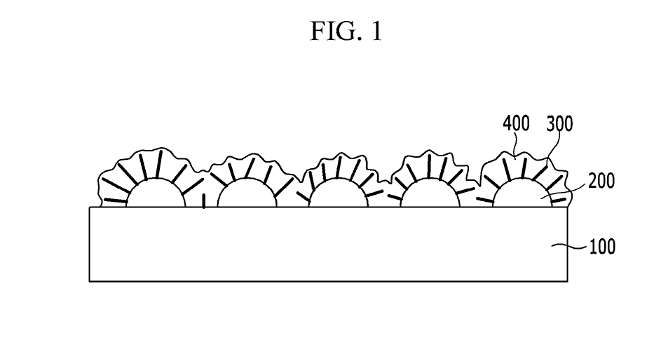

FIG. 1 is a schematic cross-sectional view of the 3D-shaped structure having the hydrophobic surface according to the exemplary embodiment of the present invention.

As illustrated in FIG. 1, the 3D-shaped structure having the hydrophobic surface according to the present invention includes a substrate 100, a first protrusion and depression portion formed on the substrate 100, a second protrusion and depression portion formed on the first protrusion and depression portion, and a protective film 400 formed on the second protrusion and depression portion.

The substrate 100 can be any structure requiring the hydrophobic surface as a basic frame for obtaining the hydrophobic surface, and may be formed of a metal. For example, the substrate may be a structure requiring various functions, such as a pipe structure for separating oil and water, a gas exchange structure, and a sound wave penetrable anti-wetting structure.

The first protrusion and depression portion has a thickness of about 100 μm or less, and includes a plurality of micro-protrusions 200 having a height of about 1 μm or less.

The second protrusion and depression portion has a thickness of 1 μm or less, and includes a plurality of nano-fibers 300 having a diameter of 200 nm or less and a length of 1 μm or less.

The protective film 400 may be a material exhibiting a hydrophobic characteristic, for example, Teflon.

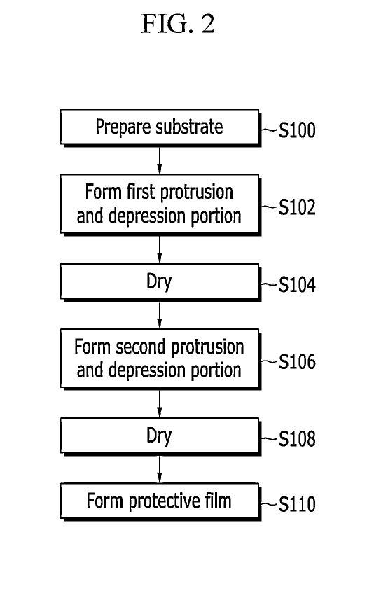

The 3D-shaped structure may be formed in the order illustrated in FIG. 2.

FIG. 2 is a flowchart illustrating a method of manufacturing the 3D-shaped structure having the hydrophobic surface according to the exemplary embodiment of the present invention.

As illustrated in FIG. 2, the method of manufacturing the 3D-shaped structure having the hydrophobic surface according to the exemplary embodiment of the present invention includes preparing the substrate (S100), forming the first protrusion and depression portion on the substrate (S102), performing drying (S104), forming the second protrusion and depression portion on the first protrusion and depression portion (S106), performing drying (S108), and forming the protective film 400 on the second protrusion and depression portion (S110).

In the exemplary embodiment of the present invention, the structure having the hydrophobic surface may be simply manufactured at a low cost by performing the aforementioned steps. Moreover, in the exemplary embodiment of the present invention, the structure may be manufactured so that a hydrophobic characteristic is provided to an internal surface or an external surface of the 3D-shaped structure by the aforementioned manufacturing steps.

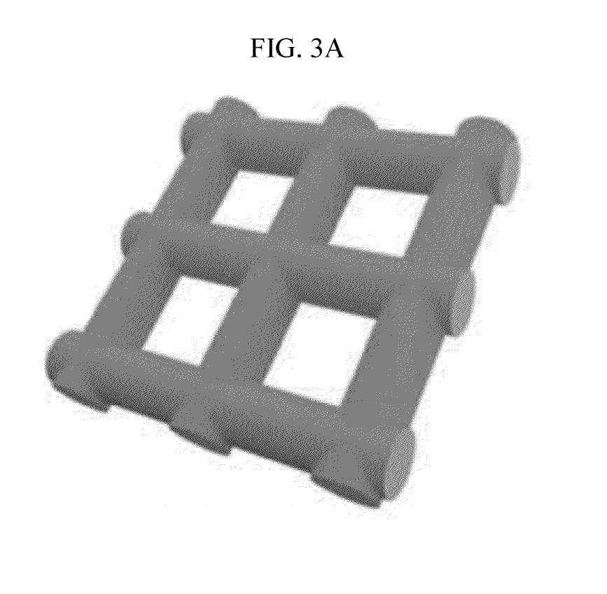

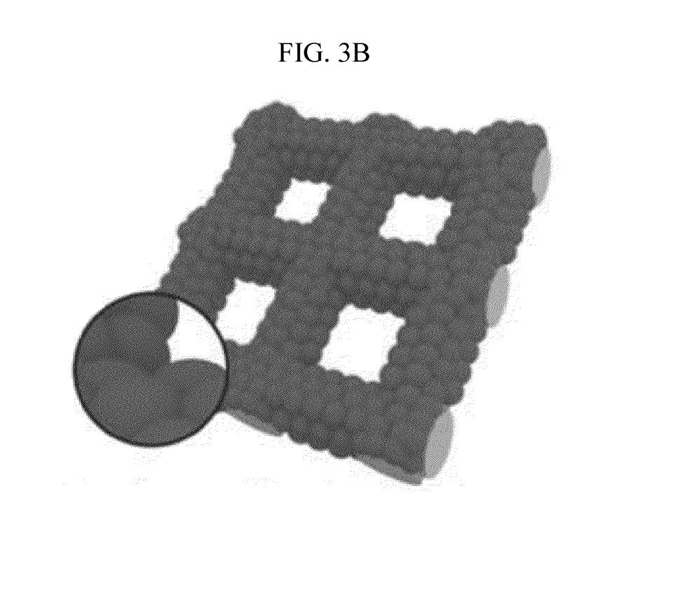

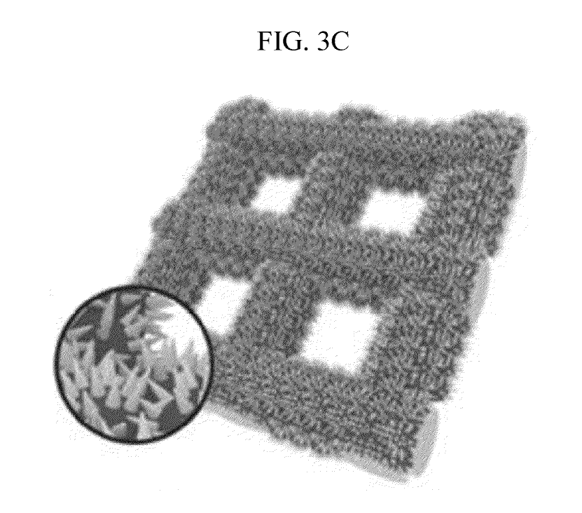

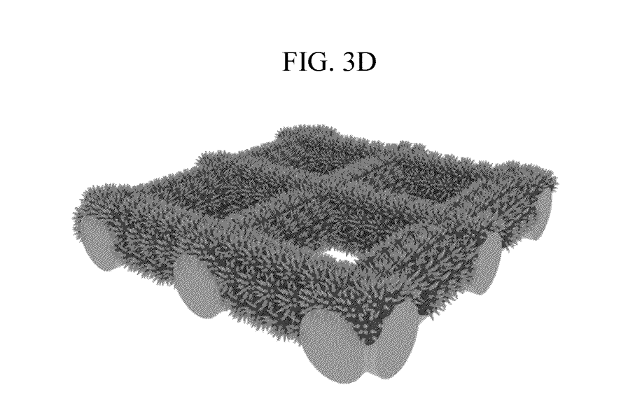

Hereinafter, the method of forming the 3D structure having the hydrophobic surface of FIGS. 3A to 3D and the aforementioned FIGS. 1 and 2 will be specifically described.

FIGS. 3A to 3D are schematic 3D views sequentially illustrating the method of forming the 3D structure having the hydrophobic surface according to the exemplary embodiment of the present invention.

First, as illustrated in FIGS. 2 and 3A, the structure for obtaining the hydrophobic surface is prepared (S100).

The structure is a mesh having a mesh structure where a horizontal portion and a vertical portion cross each other, and a hole of the mesh may have a width of about 67 μm or less. The mesh may be formed of stainless steel.

As illustrated in FIGS. 2 and 3B, the first protrusion and depression portion formed of the plurality of micro-protrusions is formed on the mesh (S102). The first protrusion and depression portion may be formed in a thickness of 100 μm or less, the height of each micro-protrusion may be 1 μm or less, and the first protrusion and depression portion is formed on the entire mesh. The micro-protrusion may be formed of any one of polypyrrole (hereinafter referred to as PPy), polyaniline (hereinafter referred to as PANI), or poly(3,4-ethylenedioxythiophene) (hereinafter referred to as PEDOT).

The first protrusion and depression portion may be formed by using electropolymerization, for example, may be formed by dipping the substrate in a water-soluble electrolyte solution including sodium dodecyl sulfate (hereinafter referred to as SDS), hydrochloric acid (HCl), and pyrrole, and then applying an electrical potential difference of 1 V to 1.5 V between the substrate and a platinum (Pt) electrode for 30 minutes to 60 minutes.

Thereafter, the first protrusion and depression portion is washed with deionized water, and then dried (S104). Drying is performed by using nitrogen gas or air having no reactivity with the first protrusion and depression portion.

As illustrated in FIGS. 2 and 3C, the second protrusion and depression portion including the plurality of nano-fibers is formed on the first protrusion and depression portion by using chemical polymerization (S106). The second protrusion and depression portion may be formed of PANI. The second protrusion and depression portion may be formed in a thickness of 1 μm or less, and each nano-fiber may have a diameter of 200 nm or less and a length of 1 μm or less. Accordingly, the nano-fiber may have a shape of downy hairs formed on a surface of a lotus leaf.

Chemical polymerization is performed by, for example, dipping in an aqueous solution including 0.1 M to 1 M perchloric acid (HClO₄), 1 mM to 10 mM ammonium persulfate (hereinafter referred to as APS), and 1 mM to 50 mM aniline for 12 hours to 24 hours. In this case, a temperature of the aqueous solution is maintained at 0° C. to 15° C.

Then, the substrate on which the second protrusion and depression portion is formed is dipped in deionized water for 1 hour to be washed and then dried (S108). Drying is performed by using the nitrogen gas or air having no reactivity with the first protrusion and depression portion.

Then, as illustrated in FIGS. 2 and 3D, after the substrate on which the second protrusion and depression portion is formed is dried in an oven, the protective film 400 is formed on the second protrusion and depression portion (S110). Drying in the oven is done to vaporize water molecules finely attached to the surface of the second protrusion and depression portion, and may be performed at a temperature of 100° C. or more and less than 250° C.

The protective film 400 may have a thickness of several tens of nanometers or less, and may be formed of Teflon or alkyltrichlorosilane.

The protective film 400 may be formed by diluting Teflon or alkyltrichlorosilane with 1H,1H,2H,2H-perfluoro-1-octanol (hereinafter referred to as FC-40), hexyltrichlorosilane (hereinafter referred to as HTS), dodecyltrichlorosilane (hereinafter referred to as DTS), or octadecyltrichlorosilane (hereinafter referred to as OTS) to apply diluted Teflon or alkyltrichlorosilane, or performing plasma polymerized fluorocarbon coating (hereinafter referred to as PPFC) and then performing curing at about 150° C. to 250° C. for about 10 minutes to about 60 minutes.

In the exemplary embodiment of the present invention, after the first protrusion and depression portion and the second protrusion and depression portion are formed, if the protective film 400 is formed on the second protrusion and depression portion, the substrate having an ultra-hydrophobic characteristic may be formed.

If the hydrophobic structure having the ultra-hydrophobic characteristic is formed, the structure having the hydrophobic characteristic is used for the purpose of, for example, provision of the hydrophobic characteristic to a pipe. Accordingly, the structure may be used in various functional devices such as a pipe structure for separating oil and water, a gas exchange structure, and a sound wave penetrable anti-wetting structure.

Hereinafter, the aforementioned exemplary embodiments of the present invention will be described in more detail through examples. However, the following examples are set forth for the purpose of the description, but are not to be construed to limit the scope of the present invention.

Forming of the 3D Structure having the Hydrophobic Surface

### EXAMPLE 1

### Manufacturing of the Tef-PPV-SS Mesh

A stainless steel mesh having a hole diameter of 100 μm was prepared. The stainless steel mesh was washed with acetone, and washed with isopropyl alcohol and deionized water (DI water).

Then, the first protrusion and depression portion having the micro-protrusions made of polypyrrole (PPy) was formed on the stainless steel (SS) mesh through electropolymerization.

The electropolymerization was performed in a water-soluble electrolyte solution including 0.5 wt % of SDS, 0.01 M HCL, and 0.1 M pyrrole. In this case, an electrical potential difference of 1.5 V was applied to the stainless steel mesh and the Pt electrode for 30 minutes.

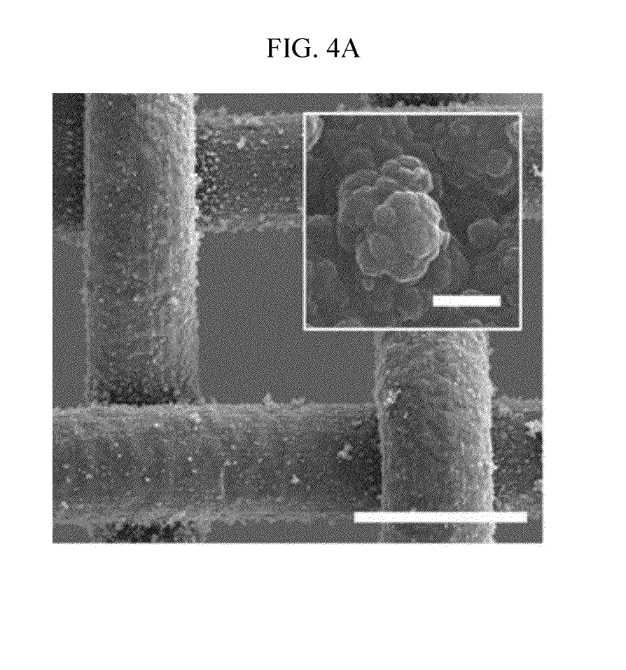

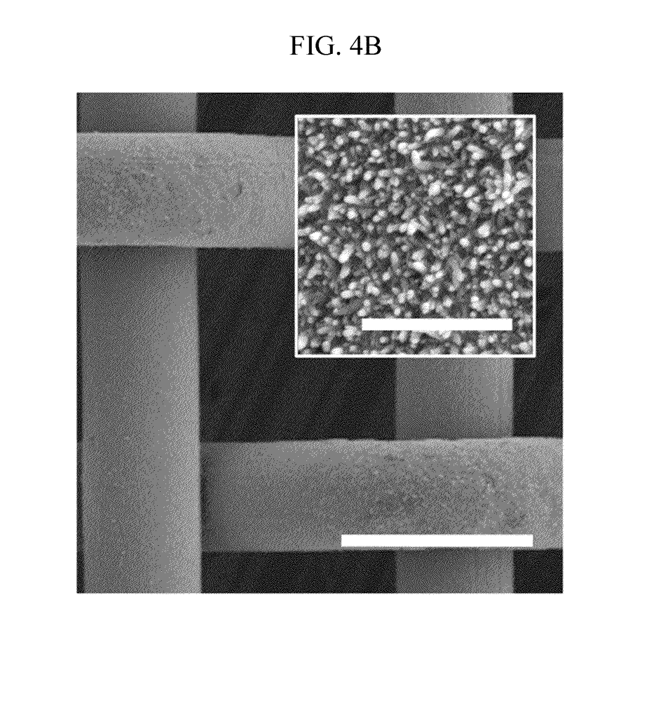

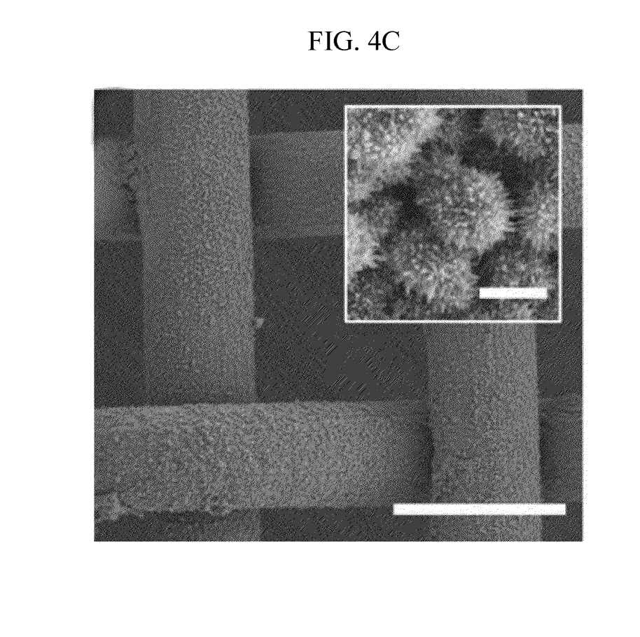

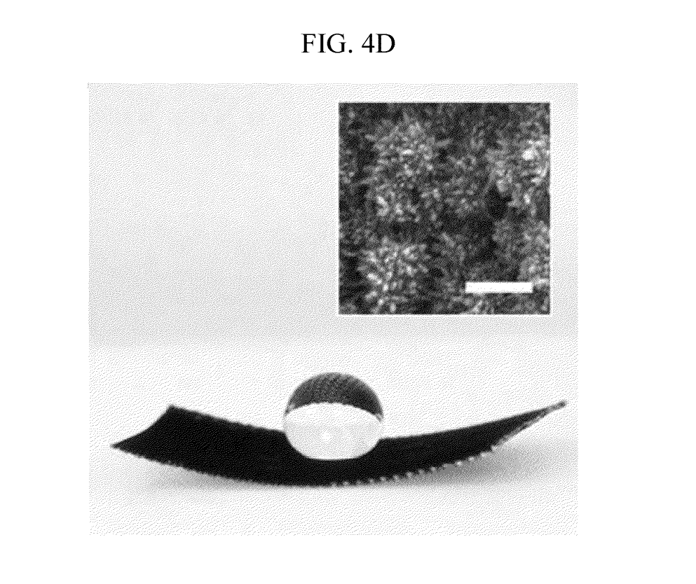

FIG. 4A is a SEM photograph of a PPy-SS mesh according to Example 1 of the present invention.

Referring to FIG. 4A, it can be confirmed that the first protrusion and depression portion is formed on the stainless steel mesh.

Thereafter, the substrate on which the first protrusion and depression portion was formed was dipped in deionized water for 1 hour to remove SDS remaining on the first protrusion and depression portion, and dried by using the nitrogen gas.

Then, water molecules of the substrate on which the second protrusion and depression portion was formed were removed in an oven at 150° C., and the Teflon (Tef) layer was formed by dipping the substrate in the 0.5% Teflon solution diluted with FC-40. In addition, the Teflon layer was cured at 200° C. for 30 minutes to complete the protective film.

### EXAMPLE 2

### Manufacturing of the Tef-PANI-SS Mesh

First, a stainless steel mesh having a hole diameter of 100 μm was prepared. The stainless steel mesh was washed with acetone, and washed with isopropyl alcohol and deionized water (DI water).

Then, the second protrusion and depression portion including the nano-fibers made of polyaniline (PANI) was formed on the stainless steel mesh by using chemical polymerization.

The chemical polymerization was performed by dipping the stainless steel mesh in an aqueous solution including 1 M HClO₄, 6.7 mM APS, and 10 mM aniline for 12 hours. In this case, aniline monomers were mixed and reacted at a temperature of 0° C. to be polymerized.

FIG. 4B is a SEM photograph of a PANI-SS mesh according to Example 2 of the present invention.

Referring to FIG. 4B, it can be confirmed that the second protrusion and depression portion is formed on the stainless steel mesh.

Thereafter, the substrate on which the second protrusion and depression portion was formed was dipped in deionized water for 1 hour to be washed and thus remove the mixture aqueous solution remaining on the second protrusion and depression portion, and dried by using the nitrogen gas.

Then, water molecules of the substrate on which the second protrusion and depression portion was formed were removed in an oven at 150° C., and the Teflon (Tef) layer was formed by dipping the substrate in a 0.5% Teflon solution diluted with FC-40. In addition, the Teflon layer was cured at 200° C. for 30 minutes to complete the protective film.

### EXAMPLE 3

### Manufacturing of the Tef-PANI-PPV-SS Mesh

A stainless steel mesh having a hole diameter of 100 μm was prepared. The stainless steel mesh was washed with acetone, and washed with isopropyl alcohol and deionized water (DI water).

Then, the first protrusion and depression portion having micro-protrusions made of polypyrrole (PPy) was formed on the stainless steel (SS) mesh through electropolymerization.

The electropolymerization was performed in the water-soluble electrolyte solution including 0.5 wt % of SDS, 0.01 M HCL, and 0.1 M pyrrole. In this case, an electrical potential difference of 1.5 V was applied to the stainless steel mesh and the Pt electrode for 30 minutes. Thereafter, the substrate on which the first protrusion and depression portion was formed was dipped in deionized water for 1 hour to remove SDS remaining on the first protrusion and depression portion, and dried by using the nitrogen gas.

Then, the second protrusion and depression portion including the nano-fibers made of polyaniline (PANI) was formed on the first protrusion and depression portion by using chemical polymerization.

The chemical polymerization was performed by dipping the substrate having the first protrusion and depression portion in the aqueous solution including 1 M HClO₄, 6.7 mM APS, and 10 mM aniline for 12 hours. In this case, aniline monomers were mixed and reacted at a temperature of 0° C. to be polymerized.

FIG. 4C is a SEM photograph of a PANI-PPy-SS mesh according to Example 3 of the present invention.

Referring to FIG. 4C, it can be confirmed that the nano-fibers of the second protrusion and depression portion uniformly cover the surfaces of the micro-protrusions of the first protrusion and depression portion. In this case, the nano-fibers may connect the adjacent micro-protrusions.

Thereafter, the substrate on which the second protrusion and depression portion was formed was dipped in deionized water for 1 hour to be washed and thus remove the aqueous solution mixture remaining on the second protrusion and depression portion, and dried by using the nitrogen gas.

Then, water molecules of the substrate on which the second protrusion and depression portion was formed were removed in an oven at 150° C., and the Teflon (Tef) layer was formed by dipping the substrate in the 0.5% Teflon solution diluted with FC-40. In addition, the Teflon layer was cured at 200° C. for 30 minutes to complete the protective film.

FIG. 4D is a SEM photograph of a Tef-PANI-PPy-SS mesh according to Example 3 of the present invention.

Referring to FIG. 4D, it can be confirmed that the protective film is formed on the second protrusion and depression portion and water drops have an almost spherical shape on the surface of the mesh.

Confirmation of the Hydrophobic Characteristic of the 3D Structure having the Hydrophobic Surface

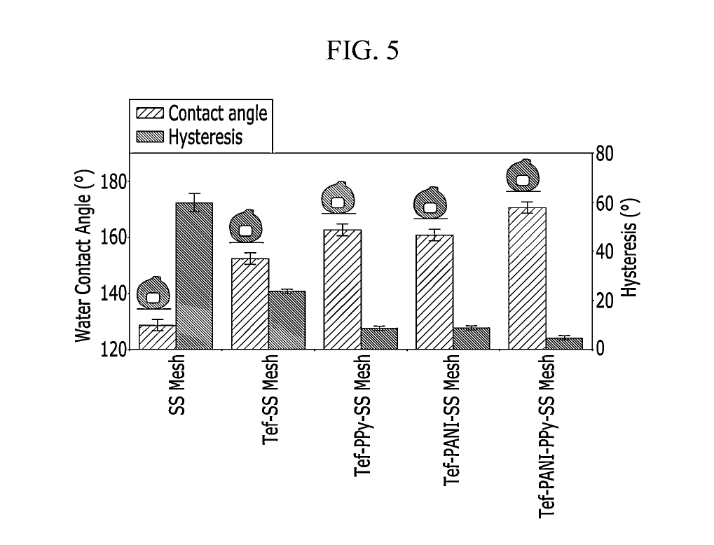

FIG. 5 is a graph obtained by measuring a static water contact angle and contact angle hysteresis of Comparative Examples 1 and 2 according to the related art and Examples 1 to 3 according to the present invention.

Example 1 is the Tef-PPy-Ss mesh, Example 2 is the Tef-PANI-SS mesh, and Example 3 is the Tef-PANI-PPy-SS mesh.

Comparative Example 1 is the stainless steel mesh (hereinafter referred to as SS mesh), and Comparative Example 2 is the mesh where the protective film formed of Teflon is formed on the stainless steel mesh (hereinafter referred to as Tef-SS mesh).

Referring to FIG. 5, it can be seen that the water contact angle is increased from Comparative Examples 1 and 2 to Examples 1 to 3. The higher the water contact angle is, the higher the hydrophobicity is, and as compared to Comparative Examples 1 and 2, the mesh including at least one of the first protrusion and depression portion that is the micro-protrusion and the second protrusion and depression portion that is the nano-protrusion like Examples 1 to 3 has increased hydrophobicity.

In addition, it can be seen that as compared to Comparative Examples 1 and 2, in Examples 1 to 3, hysteresis is reduced. Hysteresis is an index exhibiting the degree of rolling of water drops, and the smaller the hysteresis is, the higher the hydrophobicity is. In Comparative Examples 1 and 2, the hysteresis value was 60° which was large, but in Examples 1 and 2, the hysteresis value was 10°, and in Example 3, the hysteresis value was less than 10°, and thus ultra-hydrophobicity was exhibited.

The static water contact angle (WCA) was measured between 5 μl ultra-pure water (DI water) drops and the surface of the nano-structure by a sessile drop method and an analysis system (DSA 100, Kruss, Germany).

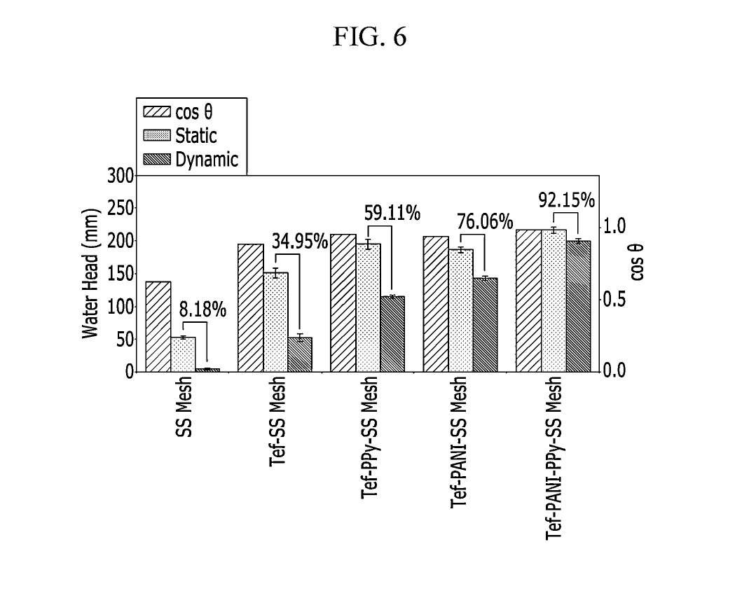

FIG. 6 is a graph obtained by measuring cos θ and static and dynamic water pressure resistances of Comparative Examples 1 and 2 according to the related art and Examples 1 to 3 according to the present invention.

Example 1 is the Tef-PPy-Ss mesh, Example 2 is the Tef-PANI-SS mesh, and Example 3 is the Tef-PANI-PPy-SS mesh.

Comparative Example 1 is the SS mesh, and Comparative Example 2 is the Tef-SS mesh.

Referring to FIG. 6, it can be seen that as compared to Comparative Examples 1 and 2, a difference between a static water pressure resistance value and a dynamic water pressure resistance value of Examples 1 to 3 is reduced. This measures a resistance value of water passing through a tube, the resistance value of water primarily passing therethrough is referred to as the static water pressure resistance value, the resistance value of water secondarily passing therethrough is referred to as the dynamic water pressure resistance value, and when there is no difference between the two values, the hydrophobicity is increased.

Referring to FIG. 6, in Comparative Example 1, the dynamic water pressure resistance value is 8.18% of the static water pressure resistance value, and in Comparative Example 2, the dynamic water pressure resistance value is 34.9% of the static water pressure resistance value, and thus a difference between the dynamic water pressure resistance value and the static water pressure resistance value is large.

However, it can be confirmed that Example 1 of the present invention has a value of 59.11%, Example 2 has a value of 76.06%, and Example 3 has a value of 92.15%, and thus the difference between the dynamic water pressure resistance value and the static water pressure resistance value is reduced to improve the hydrophobic characteristic.

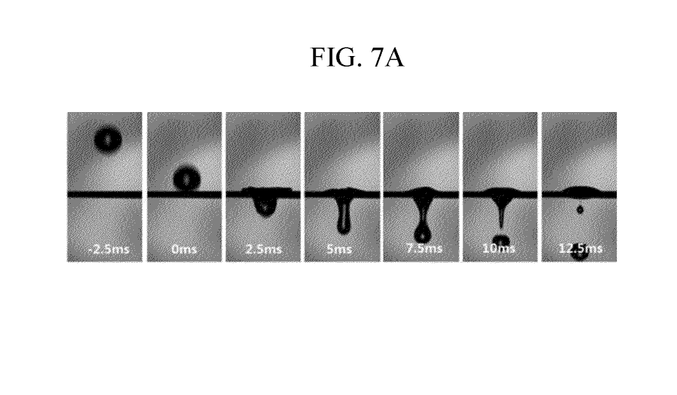

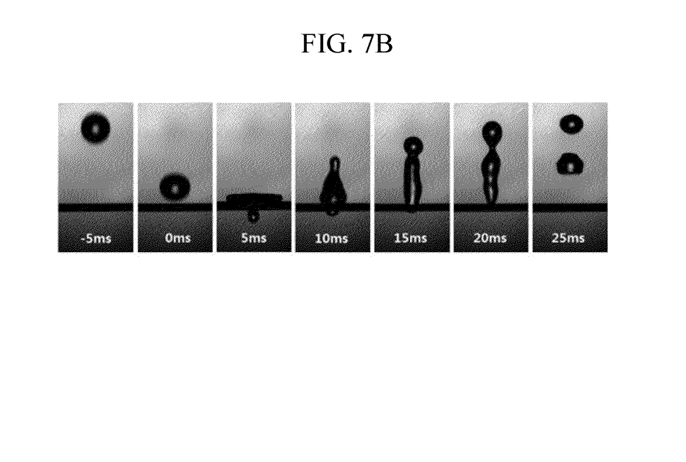

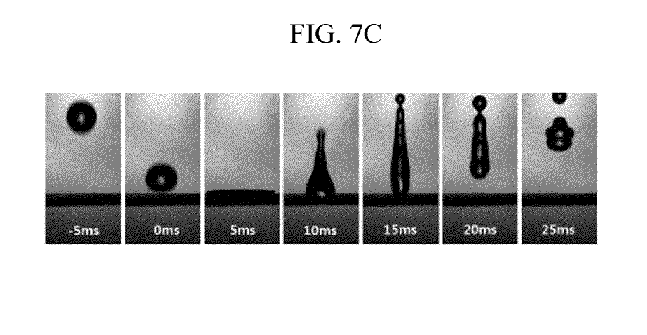

FIGS. 7A to 7C are continuous photographs of intrusion of water drops in Comparative Examples 1 and 2 according to the related art and Example 3 of the present invention.

Example 3 is the Tef-PANI-PPy-SS mesh, Comparative Example 1 is the SS mesh, and Comparative Example 2 is the Tef-SS mesh.

Herein, the water drops had the diameter of 2.5 mm, and collided at a speed of 1 m/s.

Referring to FIG. 7A, in Comparative Example 1, the water drops passed through the mesh to fall down. In addition, referring to FIG. 7B, in Comparative Example 2, the water drops partially passed through the mesh, and then bounced out.

However, referring to FIG. 7C that is Example 3 of the present invention, it can be seen that the water drops do not pass through the mesh but bounce out. That is, in Example 3 according to the present invention, the hydrophobicity was increased as compared to Comparative Examples 1 and 2.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A 3D-shaped structure having a hydrophobic surface, comprising:
a substrate;
a protrusion and depression portion formed on the substrate; and
a protective film formed on the protrusion and depression portion,
wherein the protrusion and depression portion includes at least one of a first protrusion and depression portion including a plurality of micro-protrusions and the second protrusion and depression portion including a plurality of nano-fibers.

2. The 3D-shaped structure of claim 1, wherein
the first protrusion and depression portion includes at least one selected from polypyrrole (PPy), polyaniline (PANI), and poly(3,4-ethylenedioxythiophene) (PEDOT).

3. The 3D-shaped structure of claim 1, wherein
the second protrusion and depression portion includes polyaniline.

4. The 3D-shaped structure of claim 1, wherein
the protective film includes Teflon or alkyltrichlorosilane.

5. The 3D-shaped structure of claim 1, wherein:
the first protrusion and depression portion has a thickness of 100 μm or less, and
a height of the micro-protrusion is 1 μm or less.

6. The 3D-shaped structure of claim 1, wherein:
the second protrusion and depression portion has a thickness of 1 μm or less; and
the nano-fiber has a diameter of 200 nm or less and a length of 1 μm or less.

7. A method of manufacturing a 3D-shaped structure having a hydrophobic surface, comprising:
forming a protrusion and depression portion on a substrate; and
forming a hydrophobic protective film on the protrusion and depression portion,
wherein the forming of the protrusion and depression portion includes at least one of forming a first protrusion and depression portion including a plurality of micro-protrusions, and forming a second protrusion and depression portion including a plurality of nano-fibers.

8. The method of claim 7, wherein:
the first protrusion and depression portion is formed by electropolymerization; and
the second protrusion and depression portion is formed by chemical polymerization.

9. The method of claim 8, wherein
the electropolymerization is performed in a water-soluble electrolyte solution including sodium dodecyl sulfate (SDS), hydrochloric acid (HCl), and pyrrole.

10. The method of claim 8, wherein
the chemical polymerization is performed in an aqueous solution including 0.1 M to 1 M perchloric acid (HClO₄), 1 mM to 10 mM ammonium persulfate (APS), and 1 mM to 50 mM aniline.
